(19) United States
(12) Patent Application Publication
(10) Pub. No.: US 2010/0110666 A1
(43) Pub. Date: May 6, 2010

(54) LAMP SOCKET ASSEMBLY, BACKLIGHT ASSEMBLY, DISPLAY DEVICE, AND METHOD OF MANUFACTURING THE DISPLAY DEVICE

(75) Inventors: Yong-Hwi Kim, Ansung-si (KR); Hyun-Chul Bae, Cheonan-si (KR); Seong-Sik Choi, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/570,560

(22) Filed: Sep. 30, 2009

(30) Foreign Application Priority Data
Oct. 30, 2008 (KR) 10-2008-0107228

(51) Int. Cl. G02F 1/13357; H01J 9/24; H01R 29/00

(52) U.S. Cl. 362/97.2; 362/97.1; 445/24; 439/168

(57) ABSTRACT

A lamp socket assembly includes a base plate, and lamp sockets, each lamp socket including a connection terminal, each connection terminal connected to a terminal of a lamp, and one or more first fixing portions, each of which is integrated with the connection terminal, penetrates the base plate, has at least one bent end, and contacts opposing surfaces of the base plate.

This application claims priority to Korean Patent Application No. 10-2008-0107228, filed on Oct. 30, 2008, and all the benefits accruing therefrom under 35 U.S.C. §119, the contents of which in its entirety are herein incorporated by reference.

### BACKGROUND OF THE INVENTION

1. Field of the Invention

This disclosure relates to a lamp socket assembly, a backlight assembly, a display device and a method of manufacturing the display device.

2. Description of the Related Art

A liquid crystal display (“LCD”) is a widely used type of flat panel display (“FPD”). An LCD includes two display panels, on which electrodes are formed, and a liquid crystal layer, which is interposed between the two display panels. The LCD rearranges liquid molecules of the liquid crystal layer by applying a voltage to the electrodes and thus controls an amount of light that passes through the liquid crystal layer. In this way, the LCD displays a desired image.

Because an LCD is not self-luminous, an LCD requires a backlight assembly, which includes a light source, i.e., a light-emitting device, to display an image. A backlight assembly provides light to a display panel from behind the display panel and functions as a surface light source, which provides uniform light to the entire surface of the display panel. A backlight assembly can be classified as a direct-type backlight assembly or an edge-type backlight assembly according to the position of a light source, which emits light. In a direct-type backlight assembly, a light source is disposed directly under a display panel. In an edge-type backlight assembly, a light sources is disposed under one or more sides of a display panel, and light emitted from the light source is delivered to the display panel via a light guide plate.

Large and ultra-slim display devices are under development. In a display device having a direct-type backlight assembly, a light source is disposed under a diffusion plate. Thus, it can be structurally difficult to make the display device ultra-slim. In particular, a thickness of a display device having a direct-type backlight assembly can be affected by a configuration of lamps (i.e., light sources) and the way in which the lamps are fixed to lamp sockets. Therefore, it is desirable to improve the disposition of lamps and the way in which the lamps are fixed to the lamp sockets.

In order to reduce the thickness of a display device, the size of the lamp sockets is desirably reduced, and the way in which the lamp sockets are coupled to a housing is desirably simplified.

### BRIEF SUMMARY OF THE INVENTION

Disclosed is a lamp socket assembly for an ultra-slim display device. Also disclosed is a backlight assembly, which includes a lamp socket assembly for an ultra-slim display device. Also disclosed is a display device, which includes a lamp socket assembly for an ultra-slim display device. In addition, disclosed is a method of manufacturing a display device, which includes a lamp socket assembly for an ultra-slim display device.

The above described and other drawbacks are alleviated by a lamp socket assembly including: a base plate; and lamp sockets, each lamp socket including a connection terminal, each connection terminal connected to a terminal of a lamp, and one or more first fixing portions, each of which is integrated with the connection terminal, penetrates the base plate, has at least one bent end and contacts opposing surfaces of the base plate.

Also disclosed is a backlight assembly including: lamps, which emit light; a base plate; and lamp sockets, each lamp socket including a connection terminal, each connection terminal connected to a respective terminal of the lamps, and one or more first fixing portions, each of which is integrated with the connection terminal, penetrates the base plate, has at least one bent end, and contacts opposing surfaces of the base plate.

Also disclosed is a display device including: a display panel, which displays an image; lamps, which provide light to the display panel; a base plate; and lamp sockets, each lamp socket including a connection terminal, each connection terminal connected to a respective terminal of the lamps, and one or more first fixing portions, each of which is integrated with the connection terminal, penetrates the base plate, has at least one bent end, and contacts opposing surfaces of the base plate.

Also disclosed is a method of manufacturing a display device. The method includes: forming lamp sockets, each lamp socket including a connection terminal, which is connected to a terminal of a lamp, and one or more first fixing portions, wherein each first fixing portion is integrated with the connection terminal, penetrates a base plate, has at least one bent end, and contacts opposing surfaces of the base plate; and mounting the lamp sockets on the base plate.

These and other features, aspects, and advantages of the disclosed embodiments will become better understood with reference to the following description and appended claims.

### BRIEF DESCRIPTION OF THE DRAWINGS

The disclosed subject matter is particularly pointed out and distinctly claimed in the claims at the conclusion of the specification. The above and other aspects, advantages, and features of the present invention will become more apparent by describing in further detail exemplary embodiments thereof with reference to the attached drawings, in which:

FIG. 1 is an exploded perspective view showing an exemplary embodiment of a display device;

FIG. 2 is a partial cross-sectional view of the display device shown in FIG. 1;

FIG. 3A is a perspective view of a lamp socket included in the display device of FIG. 1;

FIG. 3B is a front view of a lamp socket included in the display device of FIG. 1;

FIG. 3C is a bottom perspective view of a lamp socket assembly included in the display device of FIG. 1;

FIG. 4 is a plan view of a base plate included in the display device of FIG. 1;

FIGS. 5A and 5B are perspective views of a lamp socket assembly included in the display device of FIG. 1;

FIG. 6 is a perspective view of a ground socket included in the display device 1 of FIG. 1;

FIG. 7 is a partial perspective view of a lower housing and an insulating pad included in the display device of FIG. 1;

FIG. 8 is a perspective view of the lamp socket assembly which is coupled to the lower housing included in the display device of FIG. 1;

FIGS. 9A and 9B are perspective views showing a process of coupling the lamp sockets included in the display device of FIG. 1 to the base plate;

FIG. 10 is an enlarged perspective view of region A shown in FIG. 9A;

FIGS. 11A through 11C are views showing an exemplary embodiment of a process of manufacturing the lamp socket assembly;

FIGS. 12 and 13 are perspective views showing an exemplary embodiment of lamp sockets included in a display device;

FIG. 14 is a bottom perspective view of a lamp socket assembly included in the display device of FIGS. 12 and 13;

FIGS. 15 and 16 are perspective views showing an exemplary embodiment of lamp sockets included in a display device; and

FIG. 17 is a bottom perspective view of a lamp socket assembly included in the display device of FIGS. 15 and 16.

The detailed description explains the disclosed embodiments, together with advantages and features, by way of example with reference to the drawings.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “below”, “beneath”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated components, steps, operations and/or elements, but do not preclude the presence or addition of one or more other components, steps, operations, elements and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the present invention are described herein with reference to illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

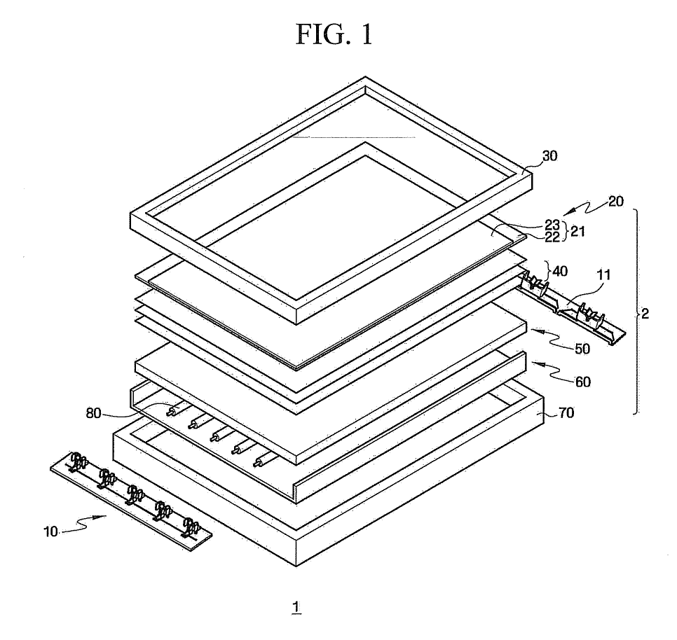

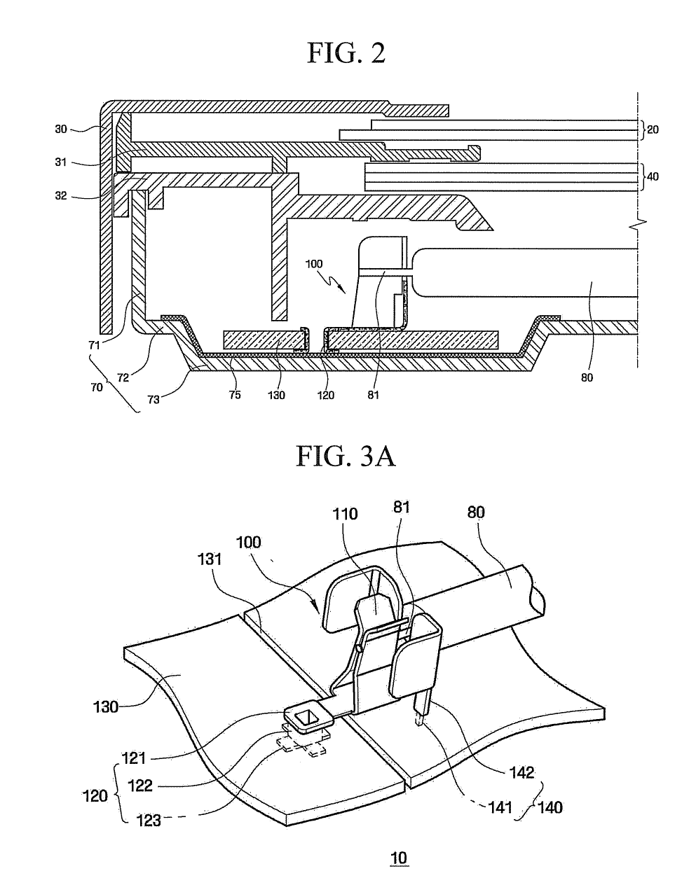

Hereinafter, an exemplary embodiment of a display device 1 is described in detail with reference to FIGS. 1 and 2. FIG. 1 is an exploded perspective view showing an exemplary embodiment of a display device. FIG. 2 is a partial cross-sectional view of the display device shown in FIG. 1.

The display device includes a display panel assembly 20, an upper housing 30 and a backlight assembly 2. The backlight assembly 2 includes optical sheets 40, a diffusion plate 50, lamps 80, a lamp socket assembly 10, a reflective sheet 60 and a lower housing 70.

The display panel assembly 20 includes a display panel 21, which has a lower display panel 22, an upper display panel 23 and a liquid crystal layer (not shown) interposed between the lower and upper display panels 22 and 23.

The display panel 21 includes the lower display panel 22, which includes gate lines (not shown), data lines (not shown) and a thin-film transistor (“TFT”) array, and the upper display panel 23, which includes a black matrix and a common electrode and faces the lower display panel 22. The display panel 21 displays image information.

The upper housing 30 forms the exterior of the display device and includes a space to accommodate the display panel assembly 20. In addition, an open window is formed in the center of the upper housing 30 to expose the display panel 21.

The upper housing 30 is coupled to the lower housing 70. When desired, intermediate frames 31 and 32, which accommodate and support the display panel 21 and the optical sheets 40, may be interposed between the upper housing 30 and the lower housing 70.

The optical sheets 40 diffuse and concentrate light that is received from the diffusion plate 50. The optical sheets 40 may be disposed on the diffusion plate 50 and housed between the upper and lower housings 30 and 70. The optical sheets 40 include a first prism sheet, a second prism sheet and a protective sheet.

The first and second prism sheets refract light that passes through the diffusion plate 50 and concentrate the light, which is incident at a low angle, to the front of the display device, thereby enhancing the brightness of the display device within an effective viewing angle range.

The protective sheet is formed on the first and second prism sheets. The protective sheet not only protects surfaces of the first and second prism sheets but also diffuses light for uniform distribution of light. The configuration of the optical sheets 40 is not limited to the above example and may vary.

The diffusion plate 50 diffuses light, which is emitted from the lamps 80, in all directions. The diffusion plate 50 prevents bright lines, which are bright portions formed by the shapes of the lamps 80, from being seen from the front of the display device.

The lamps 80 may be cold cathode fluorescent lamps (“CCFL”s), hot cathode fluorescent lamps (“HCFL”s) or the like. When the lamps 80 are HCFLs, each of the HCFLs includes two terminals at both ends thereof. The terminals are inserted into lamp sockets 100 and a ground socket 11 to receive electrical power.

The lamp sockets 100 are mounted on a base plate 130 to form the lamp socket assembly 10. The lamp socket assembly 10 is inserted into a concave portion 73, which is formed in a bottom surface 72 of the lower housing 70. In an embodiment, an insulating pad 75 is interposed between the lamp socket assembly 10 and the lower housing 70.

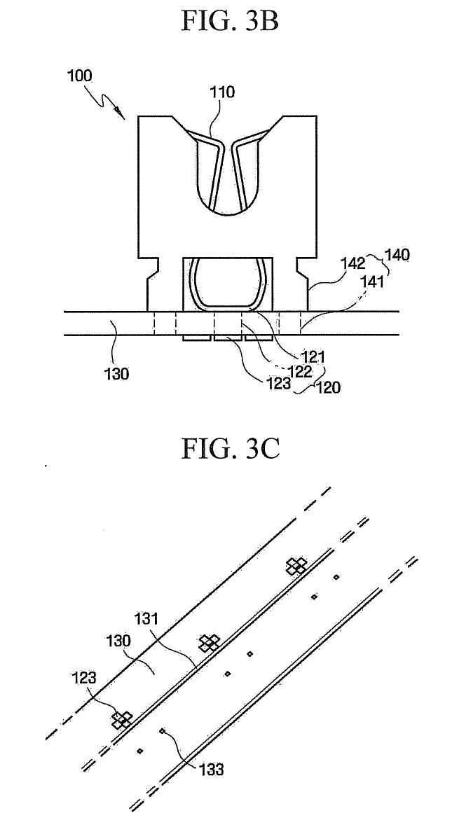

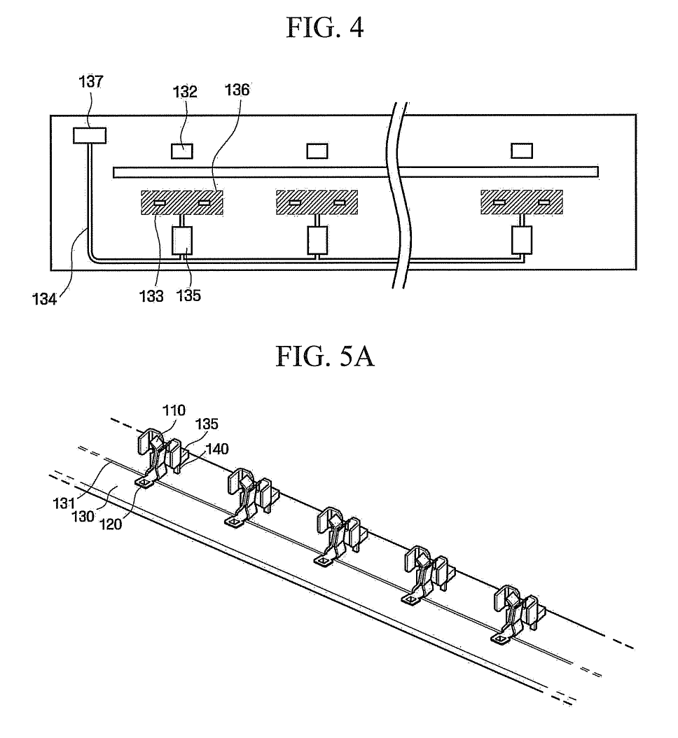

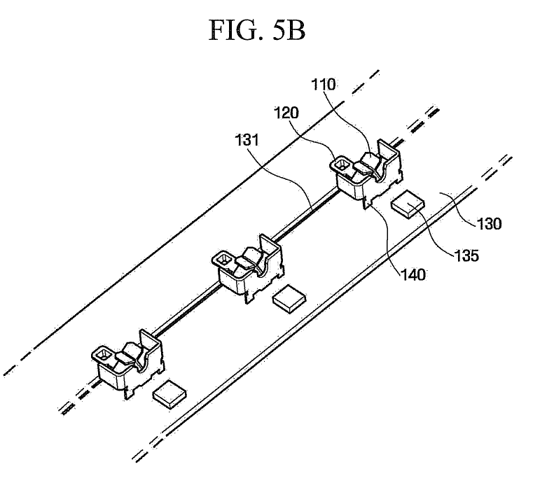

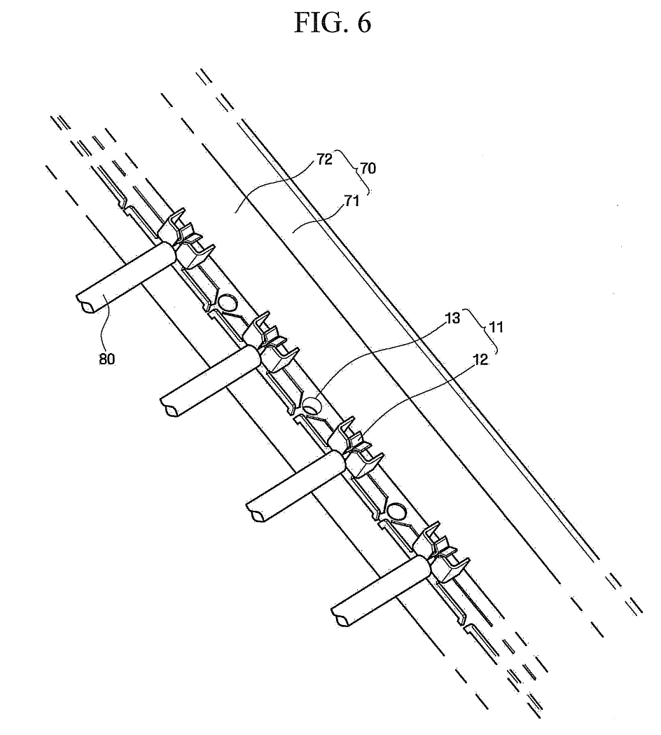

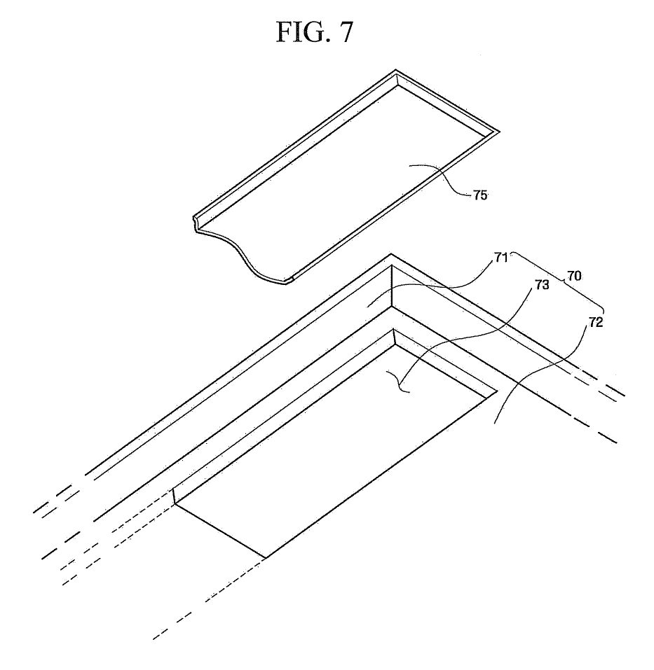

The lamp socket assembly 10 is described in detail with reference to FIGS. 3A through 5B. FIG. 3A is a perspective view showing an exemplary embodiment of a lamp socket included in the display device of FIG. 1. FIG. 3B is a front view of a lamp socket included in the display device of FIG. 1. FIG. 3C is a bottom perspective view of the lamp socket assembly 10 included in the display device of FIG. 1. FIG. 4 is a plan view of the base plate 130 included in the display device of FIG. 1. FIGS. 5A and 5B are perspective views of the lamp socket assembly 10 included in the display device of FIG. 1.

The lamp socket assembly 10 includes the base plate 130 and the lamp sockets 100, which are mounted on the base plate 130.

Referring to FIGS. 3A through 3C, the lamps 80 are fixed to the lamp sockets 100 and supplied with electrical power through the lamp sockets 100. Each of the lamp sockets 100 includes a connection terminal 110, a first fixing portion 120 and one or more second fixing portions 140. Each of the lamp sockets 100 may comprise a conductive material, such as a metal. The connection terminal 110, the first fixing portion 120 and the second fixing portions 140 may be integrated with each other.

A first end 81 of each of the lamps 80 is electrically and physically connected to the connection terminal 110, and power is supplied to each of the lamps 80 through the connection terminal 110. In an embodiment the first end 81 of each of the lamps 80 is connected to and thus fixed to the connection terminal 110. The connection terminal 110 may be elastic to allow the first end 81 of each of the lamps 80 to be connected thereto or removed therefrom. In an exemplary embodiment, the connection terminal 110 may be shaped like tongs between which the first end 81 of the lamp 89 can be gripped with a selected force. The connection terminal 110 grips the first end 81 of each of the lamps 80 with a selected force and thus holds the first end 81 in place. Since the connection terminal 110 is structured like tongs, each of the lamps 80 can be connected or removed to/from the connection terminal 110. The connection terminal 110 may be formed from sheet metal. The connection terminal 110 may be integrated with the first and second fixing portions 120 and 140, respectively, and thus fixed to the base plate 130.

The first fixing portion 120 fixes each of the lamp sockets 100 to the base plate 130. The first fixing portion 120 includes a head portion 121, a connecting portion 122 and a protruding portion 123. The first fixing portion 120 captures opposing surfaces of the base plate 130 to prevent the lamp sockets 100 from separating from the base plate 130. In an embodiment, an end of the first fixing portion 120 is disposed on a surface (hereinafter, referred to as a first surface) of the base plate 130, and the other end thereof is disposed on the a second surface, which is opposed to the first surface with respect to the base plate 130. The two ends of the first fixing portion 120 are pressed against each other with the base plate 130 interposed therebetween, thereby fixing the lamp sockets 100 to the base plate 130.

In an embodiment, the first fixing portion 120 includes the head portion 121, the connecting portion 122 and the protruding portion 123, which are connected to each other. The head portion 121 is wider than a cross section of each of the first insertion holes 132 (see FIG. 4) into which the connecting portion 122 is inserted. The head portion 121 is disposed on the first surface of the base plate 130, and the connecting portion 122, which is connected to the head portion 121, is inserted into each of the first insertion holes 132. In an exemplary embodiment, a length of the connecting portion 122 may be smaller than a thickness of the base plate 130. A cross-sectional shape of the connecting portion 122 may be identical to that of each of the first insertion holes 132. In an embodiment, an outer surface of the connecting portion 122 may contact an inner surface of each of the first insertion holes 132, thereby reducing or effectively preventing movement of each of the lamp sockets 100. In an embodiment, an outer surface of the connecting portion 122 is connected to an inner surface of each of the first insertion holes 132.

The protruding portion 123 protrudes from the second surface of the base plate 130 and is bent substantially parallel to the base plate 130 to contact to the second surface of the base plate 130. In an embodiment, the protruding portion 123 is connected to the second surface of the base plate 130. Since the head portion 121 and the protruding portion 123 of the first fixing portion 120 respectively capture the first and second surfaces of the base plate 130, each of the lamp sockets 100 can be fixed to the base plate 130. The protruding portion 123 can include a number of branches that extend from the connecting portion 122 in various directions to be parallel to the base plate 130. The head portion 121, the connecting portion 122 and the protruding portion 123 may be made of a conductor, such as a metal, and thus can function as wiring for delivering electrical power.

(Please consider illustrating the hidden portion of connection portion 122 with dashed lines in FIG. 3A.)

Like a rivet, which is a mechanical coupling element, the head portion 121 and the protruding portion 123 may be securely and respectively attached to opposing surfaces (i.e., the first and second surfaces) of the base plate 130 while being partially transformed by a force applied onto both surfaces of the base plate 130.

As described above, a portion of the first fixing portion 120 may penetrate through each of the first insertion holes 132 of the base plate 130, and the first fixing portion 120 may be coupled to the base plate 130 by the head portion 121 and the protruding portion 123, which are disposed on opposing surfaces of the base plate 130, respectively. However, the disclosed embodiments are not limited thereto. In an embodiment, the first fixing portion 120 may be coupled to the base plate 130 in various ways. In an exemplary embodiment, the first fixing portion 120 may be shaped like tongs and coupled to an edge portion of the base plate 130. In an embodiment, wherein the head portion 121 and the protruding portion 123 are disposed on opposing surfaces of the base plate 130, respectively, the connection portion 122 may not penetrate the base plate 130. In an embodiment, the connecting portion 122 may be disposed on a side surface of the base plate 130. Thus, although a through-hole is not formed in the base plate 130, the first fixing portion 120 can be coupled to the base plate 130.

The second fixing portions 140 can reduce or effectively prevent the movement of each of the lamp sockets 100. For example, in an embodiment wherein each of the lamp sockets 100 is fixed to the base plate 130 by only the first fixing portion 120, which is inserted into a corresponding first insertion hole, it may rotate or move on the corresponding first insertion hole. To prevent this movement, each of the lamp sockets 100 may further include one or more second fixing portions 140.

Each of the second fixing portions 140 includes a support portion 142 and an insertion portion 141. The support portion 142 is connected to the connection terminal 110 and has a greater cross-section than that of each of second insertion holes 133. The insertion portion 141 extends from the support portion 142 and is inserted into each of the second insertion holes 133. A length of the insertion portion 141 is equal to or smaller than the thickness of the base plate 130. Thus, the insertion portion 141 does not protrude from the second surface of the base plate 130.

The lamp sockets 100, each including the connection terminal 110, the first fixing portion 120, and the second fixing portions 140, may be formed from sheet metal.

The base plate 130 on which the lamp sockets 100 are mounted is described in detail with reference to FIGS. 3C and 4.

The base plate 130 functions as an alignment plate on which the lamp sockets 100 (see FIG. 3A) are mounted. Wiring 134 is printed on the base plate 130 to deliver power to the lamp sockets 100. The base plate 130 includes a power connector 137, the wiring 134, capacitors 135, conductive regions 136, the first insertion holes 132 and the second insertion holes 133.

The power connector 137 is electrically connected to a power source, which provides power to the lamps 80 (see FIG. 1), and is electrically connected to the capacitors 135 by the wiring 134. In an embodiment, voltages for driving the lamps 80 are applied to the power connector 137 and delivered to the lamp sockets 100 via the wiring 134 and the capacitors 135.

In an embodiment, the lamps 80 are electrically connected in parallel to each other, and a same voltage is applied to each of the lamps 80. The capacitors 135 are electrically connected to the lamp sockets 100, which are also electrically connected to the lamps 80, respectively. The capacitors 135 can reduce or effectively prevent a voltage difference between voltages applied to the lamps 80. In an embodiment, since lamp-driving voltages are applied to the lamps 80 via the capacitors 135, respectively, the voltage difference between the lamps 80 can be reduced or effectively prevented.

As described above, the lamp sockets 100 are electrically connected to the capacitors 135, respectively. Thus, in an embodiment, a balance circuit on a separate circuit board can be omitted. To implement a balance circuit, various electronic parts, such as coils, which generate a high electric field and high magnetic field, are mounted on a circuit board. In this case, since the electronic parts can affect the lamps, a distance must be maintained between each electronic part and the lamps. However, when a distance is maintained between the lamps and the circuit board, the thickness of a display device increases. Therefore, if the circuit board having the balance circuit mounted thereon is removed, the overall thickness of the display device can be significantly reduced.

In an embodiment, the capacitors 135 may be multi-layer ceramic capacitors (“MLCC”s). An MLCC uses multiple layers of high-k ceramic materials as a dielectric material interposed between electrodes. The MLCC may be small in size and have high capacitance.

The conductive regions 136 are formed on the base plate 130 and electrically connect the lamp sockets 100 to the capacitors 135, respectively. Like the wiring 134, the conductive regions 136 may comprise a conductive material and can be printed on the base plate 130. When the lamp sockets 100 contact the conductive regions 136, respectively, electric current flows from the conductive regions 136 to the lamp sockets 100, respectively. The conductive regions 136 may be respectively connected to pairs of the second insertion holes 133 as shown in FIG. 4 or may be connected to the first insertion holes 132, respectively. Therefore, a driving voltage applied to each of the conductive regions 136 through a corresponding capacitor is delivered to the first fixing portion 120 or both of the first and second fixing portions 140. Then, the driving voltage is delivered to each of the lamps 80 via the connection terminal 110, which is integrated with the first and second fixing portions 120 and 140. In an embodiment, when the first and second fixing portions 120 and 140 closely contact each of the conductive regions 136, the conductive regions 136 are coupled and electrically connected to the lamp sockets 100, respectively.

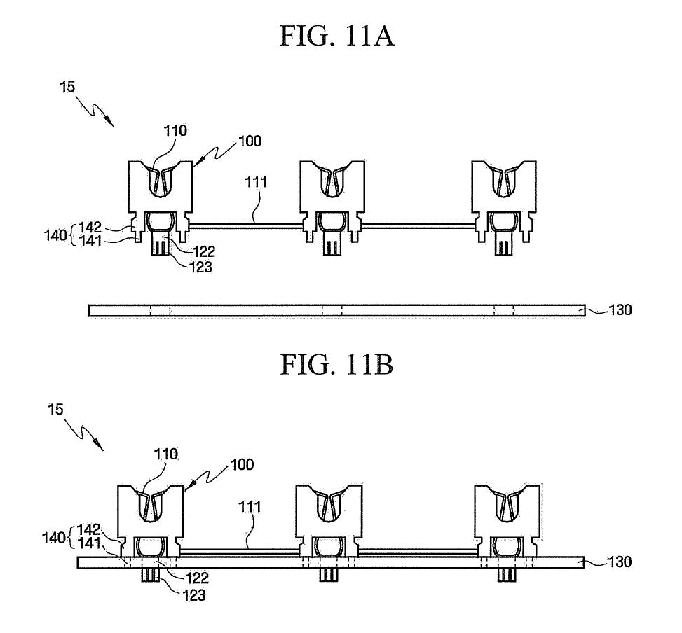

A slit 131 provides a passage into which a cutter C (see FIG. 9A) is inserted to remove a connecting metal 111 (see FIG. 9A). The slit 131 is described in more detail hereinafter.

Referring to FIGS. 5A and 5B, the lamp socket assembly 10 includes the lamp sockets 100, which may be linearly arranged on the base plate 130. The lamp socket assembly 10 may be formed on a side of a group of the lamps 80 to which power is applied. Here, the power may be high-voltage alternating current (“AC”).

If desired, the lamp socket assembly 10 may be disposed on opposing sides of the group of the lamps 80.

In an embodiment, the capacitors 135 may be disposed under the lamps 80.

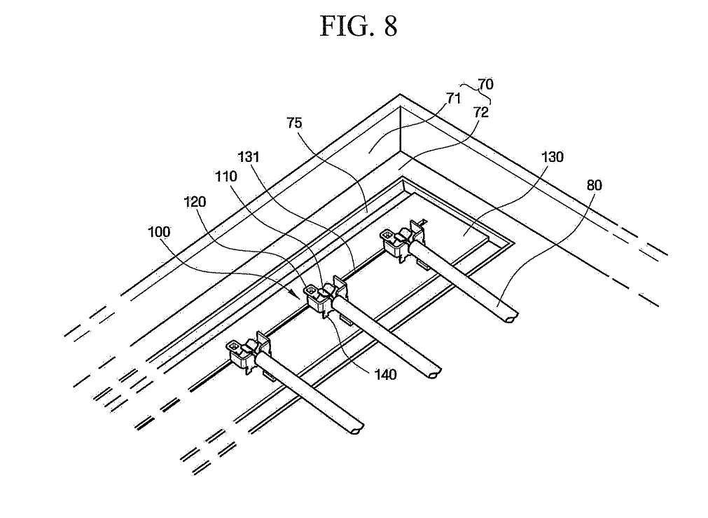

The ground socket 11 is described in detail with reference to FIG. 6. FIG. 6 is a perspective view of the ground socket 11 included in the display device of FIG. 1.

The ground socket 11 is connected to a second end of each of the lamps 80. In addition, the ground socket 11 is coupled to the lower housing 70 and thus grounded. The ground socket 11 may comprise a conductive material such as a metal plate. The ground socket 11 may include a plurality of socket portions 12 and an alignment plate 13, which may be integrated with each other.

The terminals of the lamps 80 are inserted into the socket portions 12, and the socket portions 12 are fixed to the alignment plate 13. The socket portions 12 and the alignment plate 13 may be formed from sheet metal. The socket portions 12 may be integrated with the alignment plate 13 and fixed to the lower housing 70.

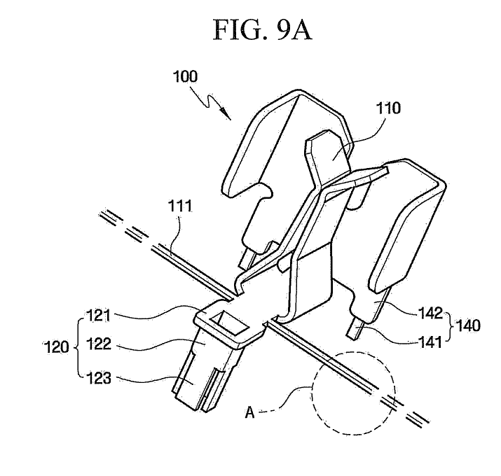

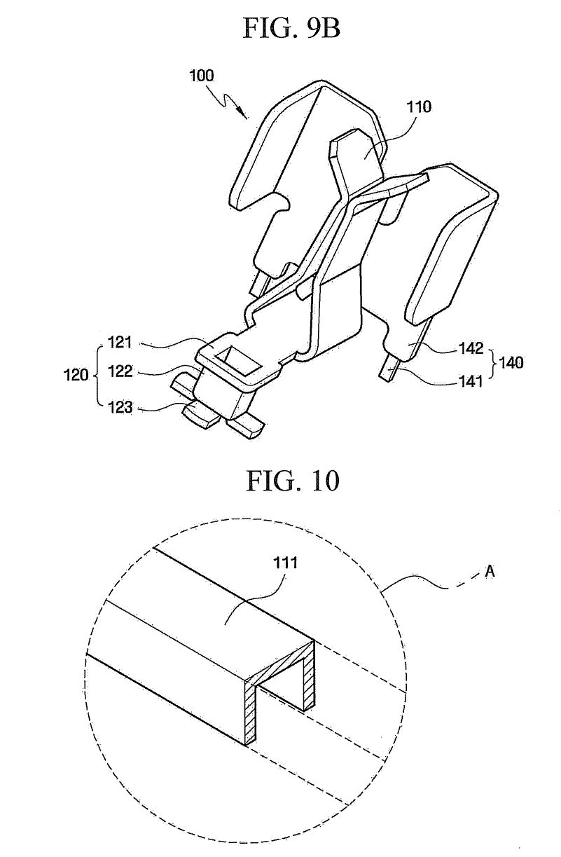

The lower housing 70 to which the lamp socket assembly 10 is coupled is described in detail with reference to FIGS. 7 and 8. FIG. 7 is a partial perspective view of the lower housing 70 and the insulating pad 75 included in the display device of FIG. 1. FIG. 8 is a perspective view of the lamp socket assembly 10, which is coupled to the lower housing 70 included in the display device of FIG. 1.

The lower housing 70 includes the bottom surface 72, sidewall portions 71 and the concave portion 73. The sidewall portions 71 surround the bottom surface 72 and accommodate the lamp socket assembly 10 and the lamps 80.

The concave portion 73 is formed in the bottom surface 72 of the lower housing 70, and the lamp socket assembly 10 is inserted into the concave portion 73. The insulating pad 75 is inserted between the concave portion 73 and the lamp socket assembly 10. The insulating pad 75 is interposed between the lamp sockets 100 and the lower housing 70 and can insulate the lamp sockets 100 from the lower housing 70.

The concave portion 73 may have a depth, which can allow the insulating pad 75 and the base plate 130 of the lamp socket assembly 10 to be inserted into the concave portion 73. In an exemplary embodiment, the insulating pad 75 may comprise an elastic member and can reduce or effectively prevent the base plate 130 from becoming unstable due to the protruding portion 123, which may protrude downward from the base plate 130.

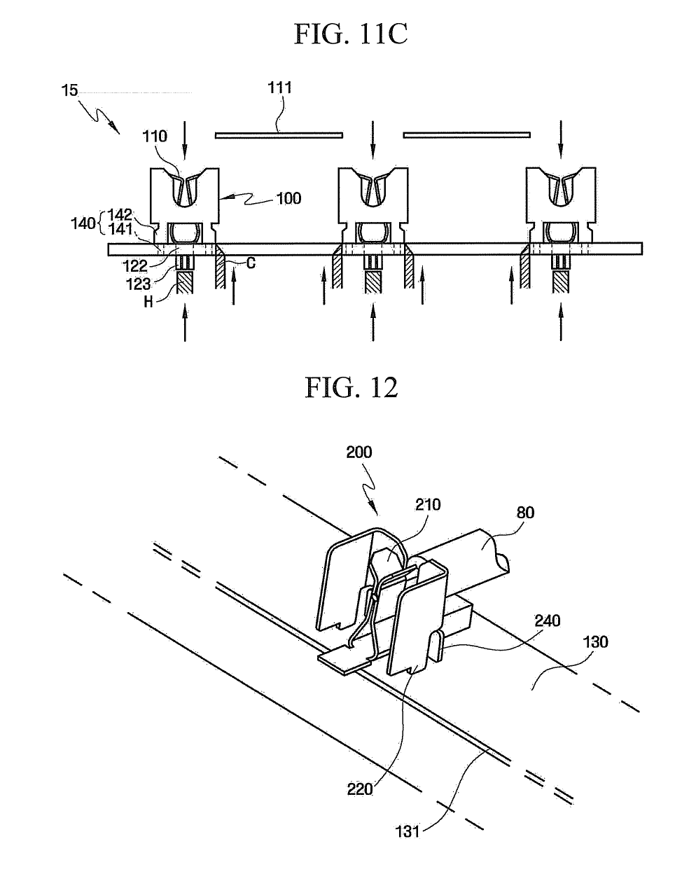

Hereinafter, a process of coupling the lamp sockets 100 to the base plate 130 is described in detail with reference to FIGS. 9A through 10. FIGS. 9A and 9B are perspective views for explaining the process of coupling the lamp sockets 100 included in the display device of FIG. 1 to the base plate 130. FIG. 10 is an enlarged perspective view of a region A shown in FIG. 9A.

Referring to FIG. 9A, the lamp sockets 100 are connected to each other by the connecting metal 111. That is, each of the lamp sockets 100 may be formed from a metal plate, and thus the connection terminal 110, the first fixing portion 120, and the second fixing portions 140 included in each of the lamp sockets 100 may be integrated with each other. In an embodiment, the lamp sockets 100 may be connected to each other by the connecting metal 111, which can facilitate assembling and handling. In an exemplary embodiment, the protruding portion 123 of the first fixing portion 120 may extend from the connecting portion 122. In addition, a cross sectional area of the protruding portion 123 may be substantially equal to that of the connecting portion 122. The support portion 142 and the insertion portion 141 of each of the second fixing portions 140 may be substantially aligned.

The connecting metal 111 connects the lamp sockets 100 to each other and can have sufficient rigidity to keep the lamp sockets 100 in place. The connecting metal 111 may be bent in a direction perpendicular to the direction in which the lamp sockets 100 are connected to each other. In an embodiment, a cross section of the connecting metal 111 may be shaped to have an angular cross-section, such as a “U” shaped cross-section, as shown in FIG. 10.

Referring to FIG. 9B, the protruding portion 123 of the first fixing portion 120 is bent perpendicular to the connecting portion 122 to fix the first fixing portion 120 to the base plate 130 (see FIG. 3A). The protruding portion 123 may be bent in at least one direction. In another exemplary embodiment, like a rivet, a force may be simultaneously applied to the head portion 121 and the bent portion 123 to bend the head portion 121 and the protruding portion 123. In an embodiment, as the head portion 121 and the protruding portion 123 are deformed, they may be coupled to each other and to the base plate 130.

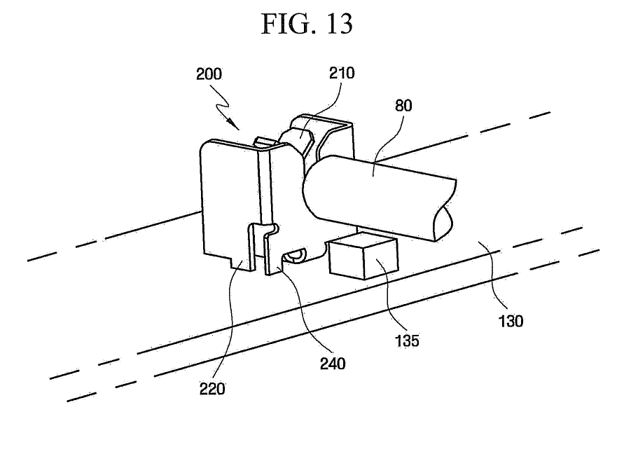

Hereinafter, a process of manufacturing the lamp socket assembly 10 is described in detail with reference to FIGS. 11A through 11C. FIGS. 11A through 11C are views, which explain a process of manufacturing the lamp socket assembly 10.

Referring to FIG. 11A, a lamp socket connector 15 is disposed on the base plate 130. The lamp socket connector 15 can be formed from sheet metal. The lamp socket connector 15 includes the lamp sockets 100, which are connected to each other by the connecting metal 111.

(Please include reference character “15” in FIGS. 11A to 11C)

The lamp sockets 100 of the lamp socket connector 15 may be automatically and collectively moved by using a robot.

Referring to FIG. 11B, the lamp socket connector 15 is inserted into the base plate 130. The connecting portion 122 of the first fixing portion 120 is inserted into the base plate 130, and the protruding portion 123 thereof protrudes downward from the base plate 130.

In an embodiment, the insertion portion 141 of each of the second fixing portions 140 is inserted into the base plate 130 but does not protrude downward from the base plate 130.

Referring to FIG. 11C, each of the lamp sockets 100 is supported by a force, and the connecting metal 111 is removed by using the cutter C, which emerges from under the base plate 130. The cutter C protrudes upward from the base plate 130 through the slit 131 (see FIG. 5A) formed in the base plate 130 and cuts the connecting metal 111.

While the connecting metal 111 is cut, the protruding portion 123 can be pressed by a pressing member H. Accordingly, the protruding portion 123 can be bent and securely attached to the base plate 130. As a result, the lamp socket assembly 10 can thus be coupled to the lower housing 70 (see FIG. 1).

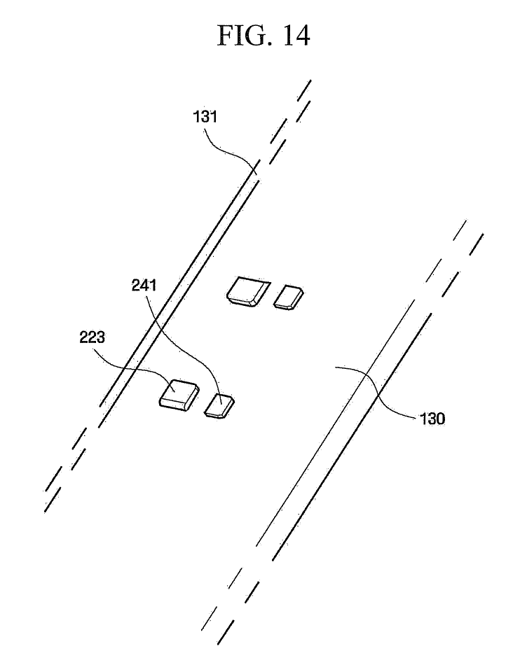

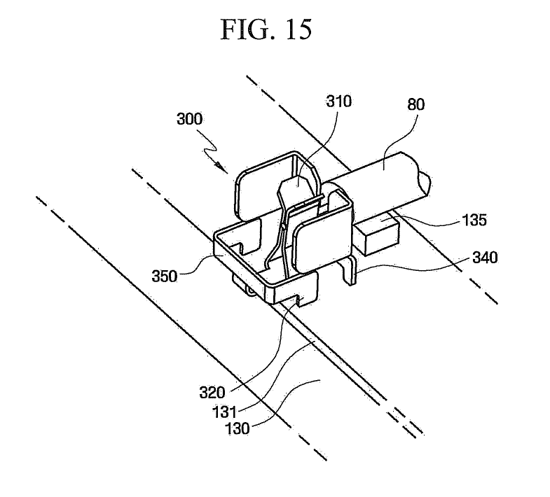

Hereinafter, another embodiment of lamp sockets 200 included in an exemplary embodiment of a display device is described in detail with reference to FIGS. 12 through 14. FIGS. 12 and 13 are perspective views of a lamp socket included in the display device. FIG. 14 is a bottom perspective view of a lamp socket assembly included in the display device of FIGS. 12 and 13. For simplicity, elements substantially identical to those of the previous exemplary embodiment are indicated by like reference numerals, and thus their description will be omitted.

Each of the lamp sockets 200 includes a pair of first fixing portions 220 and a pair of second fixing portions 240. End portions of the first and second fixing portions penetrate into the base plate 130 and are bent to contact a base plate 130.

Each of the lamp sockets 200 includes a connection terminal 210, the first fixing portions 220 and the second fixing portions 240. The first fixing portions 220 may be formed at both ends of each of the lamp sockets 200, respectively. In addition, a protruding portion 223 may penetrate the base plate 130 and be bent in a direction substantially parallel to a surface the base plate.

An insertion portion 241 of each of the second fixing portions 240 penetrates the base plate 130 and protrudes downward from the base plate 130. Like the protruding portion 223, the insertion portion 241 is bent and contacts the base plate 130.

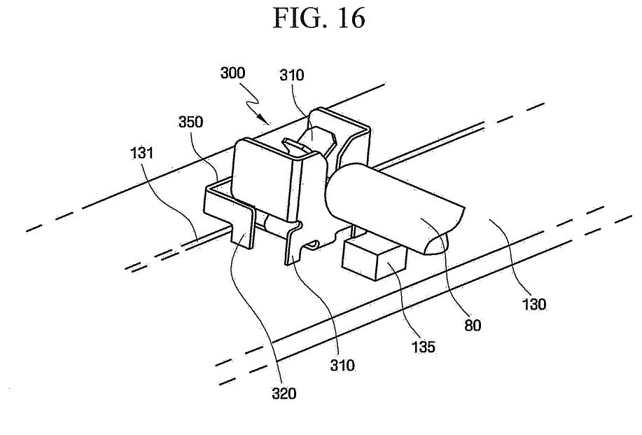

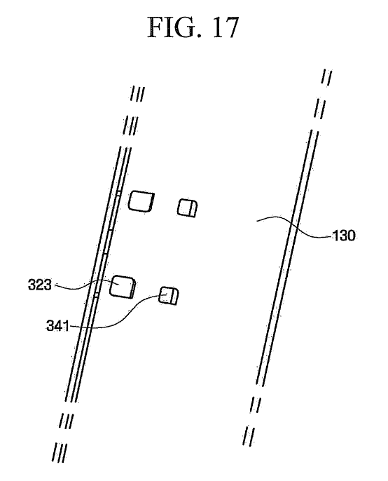

Hereinafter, another exemplary embodiment of lamp sockets 300 included in a display device is described in detail with reference to FIGS. 15 to 17. FIGS. 15 and 16 are perspective views of a lamp socket. FIG. 17 is a bottom perspective view of a lamp socket assembly including the lamp sockets 300 of FIGS. 15 and 16. For simplicity, elements substantially identical to those of the previous exemplary embodiments are indicated by like reference numerals, and thus their description will be omitted.

The lamp sockets 300 are a modified example of the exemplary embodiment shown in FIGS. 12-14. Each of the lamp sockets 300 includes a pair of first fixing portions 320, which are connected to each other.

Each of the lamp sockets 300 includes a connection terminal 310, the first fixing portions 320, a pair of second fixing portions 340, and a bending portion 350. The first fixing portions 320 may respectively be formed at both ends of each of the lamp sockets 300, respectively. The first fixing portions 320 may be connected to each other by the bending portion 350 to more securely fix each of the lamp sockets 300 to a base plate 130. A protruding portion 323 of each of the first fixing portions 320 may penetrate the base plate 130 and be bent in a direction substantially parallel to the base plate.

The bending portion 350 may connect the first fixing portions 320 to the connection terminal 310. The bending portion 350 may be integrated with the connection terminal 310 and provide elasticity between the first fixing portions 320 and the connection terminal 310. In an embodiment, the bending portion 350 as well as the first fixing portions 320 and the connection terminal 310 may comprise a metal plate. Thus, the bending portion 350 may be elastic, like a leaf spring. Since the bending portion 350 absorbs some of the impact that is applied onto the connection terminal 310, it can reduce or effectively prevent damage to the lamps 80.

An insertion portion 341 of each of the second fixing portions 340 penetrates the base plate 130 and protrudes downward from the base plate 130. Like the protruding portion 323, the insertion portion 341 is bent and contacts the base plate 130.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A lamp socket assembly comprising:
a base plate; and
lamp sockets, each lamp socket comprising a connection terminal, each connection terminal connected to a terminal of a lamp, and one or more first fixing portions, each of which is integrated with the connection terminal, penetrates the base plate, has at least one bent end and contacts opposing surfaces of the base plate.

2. The assembly of claim 1, wherein each of the first fixing portions further comprises
a head portion, which contacts a first surface of the base plate;
a connecting portion, which extends from the head portion and penetrates the base plate; and
a protruding portion, which is connected to the connecting portion and contacts a second surface of the base plate, the second surface opposing the first surface with respect to the base plate.

3. The assembly of claim 1, further comprising one or more second fixing portions, each of which is integrated with the connection terminal and comprises an insertion portion having an end, the end inserted into the base plate.

4. The assembly of claim 3, wherein the insertion portion protrudes from the second surface of the base plate and is bent to contact the base plate.

5. The assembly of claim 1, further comprising capacitors, which are mounted on the base plate, wherein a first terminal of each of the capacitors is electrically connected to a respective connection terminal, and a second terminal of each of the capacitors is electrically connected to a power source.

6. The assembly of claim 1, further comprising a bending portion, which connects the first fixing portions to each other and is integrated with the first fixing portions.

7. A backlight assembly comprising:
lamps, which emit light;
a base plate; and
lamp sockets, each lamp socket comprising a connection terminal, each connection terminal connected to a respective terminal of the lamps, and one or more first fixing portions, each of which is integrated with the connection terminal, penetrates the base plate, has at least one bent end, and contacts opposing surfaces of the substrate.

8. The backlight assembly of claim 7, wherein each of the first fixing portions further comprises
a head portion, which contacts a first surface of the base plate;
a connecting portion, which extends from the head portion and penetrates the base plate; and
a protruding portion, which is connected to the connecting portion and contacts a second surface of the base plate, the second surface opposing the first surface with respect to the base plate.

9. The backlight assembly of claim 7, further comprising one or more second fixing portions, each of which is integrated with the connection terminal and comprises an insertion portion having an end, the end inserted into the base plate.

10. A display device comprising:
a display panel, which displays an image;
lamps, which provide light to the display panel;
a base plate; and
lamp sockets, each lamp socket comprising a connection terminal, each connection terminal connected to a respective terminal of the lamps, and one or more first fixing portions, each of which is integrated with the connection terminal, penetrates the base plate, has at least one bent end, and contacts opposing surfaces of the base plate.

11. The display device of claim 10, wherein each of the first fixing portions further comprises
a head portion, which contacts a first surface of the base plate;
a connecting portion, which extends from the head portion and penetrates the base plate; and
a protruding portion, which is connected to the connecting portion and contacts a second surface of the base plate, the second surface opposing the first surface with respect to the base plate.

12. The display device of claim 10, further comprising one or more second fixing portions, each of which is integrated with the connection terminal and comprises an insertion portion having penetrated into the base plate.

13. The display device of claim 12, wherein the insertion portion protrudes from the second surface of the base plate and is bent to contact to the base plate.

14. The display device of claim 10, further comprising capacitors, which are mounted on the base plate, wherein a first terminal of each of the capacitors is electrically connected to a respective connection terminal, and a second terminal of each of the capacitors is electrically connected to a power source.

15. The display device of claim 10, further comprising a housing, which accommodates the lamps, the base plate and the lamp sockets and comprises a concave portion disposed in a bottom surface thereof, wherein the base plate is disposed in the concave portion.

16. The display device of claim 15, further comprising an insulating pad, which is interposed between the housing and the lamp sockets.

17. The display device of claim 10, further comprising a bending portion, which connects the first fixing portions to each other and is integrated with the first fixing portions.

18. A method of manufacturing a display device, the method comprising:
forming lamp sockets, each lamp socket comprising a connection terminal, which is connected to a terminal of a lamp, and one or more first fixing portions, wherein each first fixing portion is integrated with the connection terminal, penetrates a base plate, has at least one bent end, and contacts opposing surfaces of the base plate; and
mounting the lamp sockets on the base plate.

19. The method of claim 18, wherein the forming of the lamp sockets further comprises forming a lamp socket connector, which comprises the lamp sockets connected by a connecting metal, the connecting metal connecting the lamp sockets.

20. The method of claim 19, wherein the mounting of the lamp sockets on the base plate further comprises
inserting the first fixing portions into the base plate; and
bending an end portion of each of the first fixing portions.
